(19) United States
(12) Patent Application Publication
(10) Pub. No.: US 2009/0190537 A1
(43) Pub. Date: Jul. 30, 2009

(54) METHOD, APPARATUS FOR DYNAMIC RESOURCE ALLOCATION METHOD IN OFDMA-BASED COGNITIVE RADIO SYSTEM AND FORWARD LINK FRAME STRUCTURE THEREOF

(76) Inventors: Sung Hyun Hwang, Gyeonggi-do (KR); Gwangzeen Ko, Seoul (KR); Myung Sun Song, Daejeon-city (KR); Soon Ik Jeon, Daejeon-city (KR); Chang Joo Kim, Daejeon-city (KR); KyungHi Chang, Seoul (KR); Jung Ju Kim, Incheon-city (KR); Sang Jun Ko, Seoul (KR)

Correspondence Address: LADAS & PARRY LLP, 224 SOUTH MICHIGAN AVENUE, SUITE 1600, CHICAGO, IL, 60604, US

(21) Appl. No.: 12/093,485

(22) PCT Filed: Nov. 14, 2006
(86) PCT No.: PCT/KR06/04779

§ 371 Date: Sep. 17, 2008

(30) Foreign Application Priority Data
Nov. 14, 2005 (KR) 10-2005-0108768
Oct. 23, 2006 (KR) 10-2006-0103135

(51) Int. Cl. H04W 72/04

(52) U.S. Cl. 370/329

(57) ABSTRACT

Provided are a dynamic resource allocation method and apparatus in an Orthogonal Frequency Division Multiple Access (OFDMA)-based cognitive radio system and a downlink frame structure of the method and apparatus. The method includes a base station (BS) selecting one of an Adaptive Modulation and Coding (AMC) subchannel allocation scheme, in which a subchannel comprising at least one bin comprising a first plurality of continuous subcarriers in a frequency domain, is allocated, and a diversity subchannel allocation scheme, in which a subchannel comprising a second plurality of scattered subcarriers in the frequency domain is allocated, according to a level of frequency selectivity of an unused idle frequency band; and the BS allocating at least one subchannel to a terminal according to the selected subchannel allocation scheme. Accordingly, downlink throughput in the cognitive radio system can be increased.

### TECHNICAL FIELD

The present invention relates to dynamic resource allocation, and more particularly, to a dynamic resource allocation method and apparatus in an Orthogonal Frequency Division Multiple Access (OFDMA)-based cognitive radio system for dynamically allocating resources according to a channel environment of a frequency band detected as an unused frequency band and a downlink frame structure of the method and apparatus.

### BACKGROUND ART

Recently, demand for wireless services, such as in mobile communication, Wireless Local Area Network (WLAN), digital broadcasting, satellite communication, Radio Frequency Identification (RFID), Ubiquitous Sensor Network (USN), Ultra Wide-Band (UWB), and Wireless Broadband (WiBro) systems, is rapidly increasing. However, since radio resources are limited while the demand for wireless services is increasing, a method of efficiently managing the limited radio resources is required.

In order to efficiently use the limited radio resources, technologically advanced nations including The United States have been developing technology for efficiently using the limited radio resources at the national level and have been active in establishing a radio policy based on the technology, and the IEEE 802.22 Wireless Regional Area Network Work Group (WRAN WG) is standardizing communication systems in a fixed environment without mobility in which Cognitive Radio (CR) technology is combined.

One advantage of IEEE 802.22, which is being standardized based on the CR technology, is that a frequency band currently used for broadcasting can be used. However, additional complexity of a base station (BS) for CR implementation, the antenna size of a receiver using a Very High Frequency (VHF) band, and quality of service (QoS) due to a frequency in common use must be considered. Technologies used for CR systems are not only IEEE 802.22 but also wireless channel management, distribution, and interference detection technologies of multiple channels and have a high possibility of being used in conjunction with next generation wireless communication technology in terms of mutual complement. Thus, combination of the CR technology and the next generation wireless communication technology is required, and to accomplish this, the present invention suggests a downlink frame structure for a CR system in a fixed environment without mobility, a method of maximizing transmission efficiency by performing data rate control using an adaptive traffic channel according to a detected channel environment in the CR system, and a method of an environment adaptive channel estimation method using a downlink preamble or pilot.

### DESCRIPTION OF THE DRAWINGS

FIG. 1 illustrates an Orthogonal Frequency Division Multiple Access (OFDMA)/Frequency Division Duplexing (FDD) (or Time Division Duplexing (TDD))-based downlink frame structure according to an embodiment of the present invention;

FIG. 2 illustrates a temporal characteristic of a preamble illustrated in FIG. 1, according to an embodiment of the present invention;

FIG. 3 is a flowchart illustrating a dynamic resource allocation method in an OFDMA-based cognitive radio system according to an embodiment of the present invention;

FIG. 4 illustrates system parameters used in an OFDMA-based cognitive radio system according to an embodiment of the present invention;

FIG. 5 is a table for describing three subchannel allocation schemes according to another embodiment of the present invention;

FIG. 6 illustrates a channel spectrum, which can be considered as a best channel illustrated in FIG. 5;

FIGS. 7A and 7B illustrate channel spectra, which can be considered as a medium channel illustrated in FIG. 5;

FIG. 8 illustrates a channel spectrum, which can be considered as a worst channel illustrated in FIG. 5;

FIG. 9 is a diagram for describing a band-type Adaptive Modulation and Coding (AMC) subchannel allocation scheme according to an embodiment of the present invention;

FIG. 10 is a diagram for describing a scattered AMC subchannel allocation scheme according to an embodiment of the present invention;

FIG. 11 is a diagram for describing a diversity subchannel allocation scheme according to an embodiment of the present invention;

FIG. 12 is a diagram for describing channel estimation in the band type AMC subchannel allocation scheme according to an embodiment of the present invention;

FIG. 13 is a diagram for describing channel estimation in the scattered AMC subchannel allocation scheme according to an embodiment of the present invention;

FIG. 14 is a diagram for describing channel estimation in the diversity subchannel allocation scheme according to an embodiment of the present invention;

FIG. 15 illustrates a subchannel allocation structure for an OFDMA/FDD-based cognitive radio system according to an embodiment of the present invention;

FIG. 16 illustrates parameters of data subcarriers, pilot subcarriers, and others for the subchannel allocation schemes according to an embodiment of the present invention; and

FIG. 17 is a block diagram of apparatuses of a base station (BS) and a terminal for performing dynamic resource allocation in an OFDMA-based cognitive radio system according to an embodiment of the present invention.

### DETAILED DESCRIPTION OF THE INVENTION

### Technical Problem

The present invention provides a dynamic resource allocation method and apparatus in an Orthogonal Frequency Division Multiple Access (OFDMA)-based cognitive radio system for increasing downlink efficiency and a downlink frame structure of the method and apparatus.

### Technical Solution

According to an aspect of the present invention, there is provided a dynamic resource allocation method in an Orthogonal Frequency Division Multiple Access (OFDMA)-based cognitive radio system, the method comprising: a base station (BS) selecting one of an Adaptive Modulation and Coding (AMC) subchannel allocation scheme in which a subchannel comprising at least one bin comprising a first plurality of continuous subcarriers in a frequency domain, is allocated and a diversity subchannel allocation scheme in which a subchannel comprising a second plurality of scattered subcarriers in the frequency domain is allocated, according to a level of frequency selectivity of an unused idle frequency band; and the BS allocating at least one subchannel to a terminal according to the selected subchannel allocation scheme.

The AMC subchannel allocation scheme may comprise a band-type AMC subchannel allocation scheme in which the subchannel is allocated with a band made up of M continuous bins in the frequency domain, where M is a natural number equal to or greater than 2, and a scattered AMC subchannel allocation scheme, in which the subchannel is allocated with a single bin or at least two bins regardless of continuity in the frequency domain, wherein the selecting comprises selecting the band-type AMC subchannel allocation scheme if the idle frequency band belongs to a best channel environment, in which the level of frequency selectivity is less than a first threshold, selecting the scattered AMC subchannel allocation scheme if the idle frequency band belongs to a medium channel environment, in which the level of frequency selectivity is equal to or greater than the first threshold and less than a second threshold, or selecting the diversity subchannel allocation scheme if the idle frequency band belongs to a worst channel environment, in which the level of frequency selectivity is equal to or greater than the second threshold.

The allocating may comprise allocating a subchannel to the terminal based on a channel state of each subchannel of the idle frequency band if the selected subchannel allocation scheme is the AMC subchannel allocation scheme.

The allocating may comprise allocating a subchannel to the terminal based on a channel state of each subchannel of the idle frequency band if the selected subchannel allocation scheme is the band-type AMC subchannel allocation scheme, and allocating a subchannel to the terminal based on a channel state of each group comprising a predetermined plurality of continuous bins in the frequency domain if the selected subchannel allocation scheme is the scattered AMC subchannel allocation scheme.

The band may comprise 4 bins, and the group may comprise 2 bins, wherein the bin comprises 15 data subcarriers, or 14 data subcarriers and one pilot subcarrier.

The diversity subchannel allocation scheme may be a subchannel allocation scheme generating J subchannels, in which K groups, each group comprising J continuous subcarriers in the frequency domain, are generated by grouping subcarriers belonging to the idle frequency band, and each subchannel is generated with subcarriers obtained by selecting one subcarrier from each group.

J may be 30, and K may be 48.

The allocating may comprise allocating an arbitrary subchannel to the terminal if the selected subchannel allocation scheme is the diversity subchannel allocation scheme.

The allocating may comprise: the BS requesting the terminal for channel state information (CSI) comprising information on a channel state of each band if the selected subchannel allocation scheme is the band-type AMC subchannel allocation scheme and information on a channel state of each group if the selected subchannel allocation scheme is the scattered AMC subchannel allocation scheme, and obtaining the CSI from the terminal; and the BS selecting a subchannel having a good channel state based on the CSI and allocating the selected subchannel to the terminal.

The channel state may be a mean Signal to Interference and Noise Ratio (SINR) of the terminal.

The CSI may comprise an identification (ID) of a predetermined number of bands or groups having a good channel state among bands or groups belonging to the idle frequency band and a channel state corresponding to the ID, wherein the allocating comprises the BS selecting a subchannel belonging to a band or group having a good channel state from among the predetermined number of bands or groups based on the CSI and allocating the selected subchannel to the terminal.

The allocating may further comprise allocating resources according to the AMC based on the channel state of each subchannel of the idle frequency band if the selected subchannel allocation scheme is the AMC subchannel allocation scheme.

The allocating may further comprise allocating resources according to the AMC based on the CSI if the selected subchannel allocation scheme is the AMC subchannel allocation scheme.

The allocating may further comprise allocating resources according to the AMC based on a channel state of the entire band of the idle frequency band if the selected subchannel allocation scheme is the diversity subchannel allocation scheme.

The channel state may be a mean Signal to Interference and Noise Ratio (SINR) of the terminal.

The allocating may comprise: if the selected subchannel allocation scheme is the diversity subchannel allocation scheme, the BS requesting the terminal for CSI comprising information on the channel state of the entire band of the idle frequency band, and obtaining the CSI from the terminal; and the BS allocating resources according to the AMC based on the CSI.

The selecting may comprise: the BS transmitting information of the idle frequency band to the terminal; the BS receiving channel environment information comprising information on the level of frequency selectivity of the idle frequency band from the terminal; and the BS selecting one of the AMC subchannel allocation scheme and the diversity subchannel allocation scheme based on the received channel environment information.

The channel environment information may contain a variance value of a channel frequency response magnitude of the idle frequency band, which is calculated by the terminal.

A downlink frame transmitted between the BS and the terminal may comprise: a slot comprising a first plurality of OFDM symbols; a frame, which has a first length of time according to a period of time for performing channel state measurement of a terminal and dynamic resource allocation of a BS and comprises a second plurality of slots; and a super frame having a second length of time and comprising a third plurality of frames.

The method may further comprise the BS detecting the idle frequency band by sensing a spectrum in a period of time N times the super frame.

N may be controlled by Media Access Control (MAC), wherein the detecting comprises the BS performing spectrum sensing of a radio frequency (RF) band by an amount of a remaining slot number using slots remaining by excluding slots including an overhead according to a preamble and a Frame Control Header (FCH) & MAP message.

The allocating may comprise disposing one pilot subcarrier at N_{f} subcarrier intervals in each pilot OFDM symbol comprising at least one pilot subcarrier and existing in a period of Nₜ OFDM symbol intervals, in which the pilot subcarriers are disposed by applying a different offset to each of K adjacent pilot OFDM symbols so that positions of the pilot subcarriers in the frequency domain are not the same between the K adjacent pilot OFDM symbols, wherein N_{f} of the AMC subchannel allocation scheme is greater than N_{f} of the diversity subchannel allocation scheme.

Each bin may comprise 15 subcarriers, Nₜ may be 5, N_{f} may be 15 in the AMC subchannel allocation scheme and 9 in the diversity subchannel allocation scheme, K may be 3, the minimum interval between offsets used in the AMC subchannel allocation scheme may have 5 subcarrier intervals, and the minimum interval between offsets used in the diversity subchannel allocation scheme may have 3 subcarrier intervals.

According to another aspect of the present invention, there is provided a downlink frame structure for dynamic resource allocation in an OFDMA-based cognitive radio system, the downlink frame structure comprising: a slot comprising a first plurality of OFDM symbols; a frame, which has a first length of time according to a period of time for performing channel state measurement of a terminal and dynamic resource allocation of a BS and comprises a second plurality of slots; and a super frame having a second length of time and comprising a third plurality of frames.

The second length of time may be 96 msec, the first length of time may be 4.8 msec, the third plurality may be 5, the second plurality may be 4, and the first plurality may be 15.

A first symbol of a frame placed at the beginning of the super frame may be a preamble for performing at least one of symbol timing, offset estimation, subcarrier frequency offset estimation, cell identification (ID) estimation, channel estimation, and acquisition of CSI that is to be reported from the terminal to the BS, wherein the preamble is repeated a predetermined number of times in a time domain.

The predetermined number of times may be 3.

According to another aspect of the present invention, there is provided a dynamic resource allocation method in an Orthogonal Frequency Division Multiple Access (OFDMA)-based cognitive radio system, the method comprising: an allocation information receiving process, wherein a terminal receives, from a base station (BS), information on a subchannel allocated according to a subchannel allocation scheme selected by the BS based on a level of frequency selectivity of an unused idle frequency band from among an Adaptive Modulation and Coding (AMC) subchannel allocation scheme in which a subchannel comprising at least one bin comprising a first plurality of continuous subcarriers in a frequency domain is allocated and a diversity subchannel allocation scheme in which a subchannel comprising a second plurality of scattered subcarriers in the frequency domain is allocated; and a communication process, wherein the terminal communicates with the BS using the allocated subchannel based on the received information on the allocated subchannel.

The AMC subchannel allocation scheme may comprise a band-type AMC subchannel allocation scheme in which the subchannel is allocated with a band made up of M continuous bins in the frequency domain, where M is a natural number equal to or greater than 2, and a scattered AMC subchannel allocation scheme, in which the subchannel is allocated with a single bin or at least two bins regardless of continuity in the frequency domain, wherein the selected subchannel allocation scheme is selected using a method of selecting the band-type AMC subchannel allocation scheme if the idle frequency band belongs to a best channel environment, in which the level of frequency selectivity is less than a first threshold, selecting the scattered AMC subchannel allocation scheme if the idle frequency band belongs to a medium channel environment, in which the level of frequency selectivity is equal to or greater than the first threshold and less than a second threshold, or selecting the diversity subchannel allocation scheme if the idle frequency band belongs to a worst channel environment, in which the level of frequency selectivity is equal to or greater than the second threshold.

The information on the allocated subchannel may be information on a subchannel allocated to the terminal based on a channel state of each subchannel of the idle frequency band if the selected subchannel allocation scheme is the AMC subchannel allocation scheme.

The information on the allocated subchannel may be information on a subchannel allocated to the terminal based on a channel state of each subchannel of the idle frequency band if the selected subchannel allocation scheme is the band-type AMC subchannel allocation scheme, or information on a subchannel allocated to the terminal based on a channel state of each group comprising a predetermined plurality of continuous bins in the frequency domain if the selected subchannel allocation scheme is the scattered AMC subchannel allocation scheme.

The information on the allocated subchannel may be information on a subchannel arbitrarily allocated to the terminal from among subchannels belonging to the idle frequency band if the selected subchannel allocation scheme is the diversity subchannel allocation scheme.

The method may further comprise a transmission process, wherein the terminal receives a request from the BS for channel state information (CSI) comprising information on a channel state of each band if the selected subchannel allocation scheme is the band-type AMC subchannel allocation scheme or information on a channel state of each group if the selected subchannel allocation scheme is the scattered AMC subchannel allocation scheme, detects a channel state of each band or each group, and transmits CSI containing the detected channel states to the BS, wherein the allocated subchannel is a subchannel having a good channel state, which is selected by the BS based on the CSI.

The channel state may be a mean Signal to Interference and Noise Ratio (SINR) of the terminal.

The CSI may comprise an identification (ID) of a predetermined number of bands or groups having a good channel state among bands or groups belonging to the idle frequency band and a channel state corresponding to the ID, wherein the allocated subchannel is a subchannel selected by the BS, which belongs to a band or group having a good channel state from among the predetermined number of bands or groups based on the CSI.

If the selected subchannel allocation scheme is the AMC subchannel allocation scheme, the allocation information receiving process may comprise receiving information on resources allocated to the terminal by the BS according to the AMC based on the channel state of each subchannel of the idle frequency band, and the communication process may comprise communicating with the BS based on the resources allocated according to the AMC.

If the selected subchannel allocation scheme is the diversity subchannel allocation scheme, the allocation information receiving process may comprise receiving information on resources allocated to the terminal by the BS according to the AMC based on a channel state of the entire band of the idle frequency band, and the communication process may comprise communicating with the BS based on the resources allocated according to the AMC.

The channel state may be a mean SINR of the terminal.

The method may further comprise: a transmission process, wherein if the selected subchannel allocation scheme is the diversity subchannel allocation scheme, the terminal receives a request from the BS for CSI comprising information on a channel state of the entire band of the idle frequency band, detects the channel state of the entire band, and transmits CSI containing the detected channel state to the BS.

The method may further comprise: the terminal receiving information on the idle frequency band from the BS; and the terminal detecting a level of frequency selectivity of the idle frequency band and transmitting channel environment information containing the detected level of frequency selectivity to the BS.

The channel environment information may contain a variance value of a channel frequency response magnitude of the idle frequency band, which is calculated by the terminal.

A downlink frame transmitted between the BS and the terminal may comprise: a slot comprising a first plurality of OFDM symbols; a frame, which has a first length of time according to a period of time for performing channel state measurement of a terminal and dynamic resource allocation of a BS and comprises a second plurality of slots; and a super frame having a second length of time and comprising a third plurality of frames.

The super frame may comprise a plurality of pilot OFDM symbols formed in a method of disposing one pilot subcarrier at N_{f} subcarrier intervals in each pilot OFDM symbol comprising at least one pilot subcarrier and existing in a period of Nₜ OFDM symbol intervals, in which the pilot subcarriers are disposed by applying a different offset to each of K adjacent pilot OFDM symbols so that positions of the pilot subcarriers in the frequency domain are not the same between the K adjacent pilot OFDM symbols, wherein the communication process comprises the terminal performing channel estimation using received pilot OFDM symbols comprised in a received signal according to the downlink frame.

A downlink frame transmitted between the BS and the terminal may comprise: a slot comprising a first plurality of OFDM symbols; a frame, which has a first length of time according to a period of time for performing channel state measurement of a terminal and dynamic resource allocation of a BS and comprises a second plurality of slots; and a super frame having a second length of time and comprising a third plurality of frames.

The super frame may comprise a plurality of pilot OFDM symbols formed in a method of disposing one pilot subcarrier at N_{f} subcarrier intervals in each pilot OFDM symbol comprising at least one pilot subcarrier and existing in a period of Nₜ OFDM symbol intervals, in which the pilot subcarriers are disposed by applying a different offset to each of K adjacent pilot OFDM symbols so that positions of the pilot subcarriers in the frequency domain are not the same between the K adjacent pilot OFDM symbols, wherein the communication process comprises the terminal performing channel estimation by copying in a time domain a reception value of pilot subcarriers contained in received pilot OFDM symbols comprised in a received signal according to the downlink frame and performing interpolation in the frequency domain, wherein if the selected subchannel allocation scheme is the band-type AMC subchannel allocation scheme, the scattered AMC subchannel allocation scheme, or the diversity subchannel allocation scheme, the channel estimation is performed by performing the interpolation in the frequency domain on a band basis, a bin basis, or an entire band basis.

According to another aspect of the present invention, there is provided a dynamic resource allocation apparatus of a base station (BS) for allocating a subchannel to a terminal in an Orthogonal Frequency Division Multiple Access (OFDMA)-based cognitive radio system, the apparatus comprising: a selector selecting one of an Adaptive Modulation and Coding (AMC) subchannel allocation scheme in which a subchannel comprising at least one bin comprising a first plurality of continuous subcarriers in a frequency domain is allocated and a diversity subchannel allocation scheme in which a subchannel comprising a second plurality of scattered subcarriers in the frequency domain is allocated, according to a level of frequency selectivity of an unused idle frequency band; and an allocation unit allocating at least one subchannel to the terminal according to the selected subchannel allocation scheme.

The apparatus may further comprise an allocation information transmitter transmitting information on the allocated subchannel to the terminal.

The AMC subchannel allocation scheme may comprise a band-type AMC subchannel allocation scheme in which the subchannel is allocated with a band made up of M continuous bins in the frequency domain, where M is a natural number equal to or greater than 2, and a scattered AMC subchannel allocation scheme, in which the subchannel is allocated with a single bin or at least two bins regardless of continuity in the frequency domain, wherein the selector selects the band-type AMC subchannel allocation scheme if the idle frequency band belongs to a best channel environment, in which the level of frequency selectivity is less than a first threshold, selects the scattered AMC subchannel allocation scheme if the idle frequency band belongs to a medium channel environment, in which the level of frequency selectivity is equal to or greater than the first threshold and less than a second threshold, or selects the diversity subchannel allocation scheme if the idle frequency band belongs to a worst channel environment, in which the level of frequency selectivity is equal to or greater than the second threshold.

According to another aspect of the present invention, there is provided a dynamic resource allocation apparatus of a terminal to which a base station (BS) allocates a subchannel, in an Orthogonal Frequency Division Multiple Access (OFDMA)-based cognitive radio system, the apparatus comprising: an allocation information receiver receiving, from the BS, information on a subchannel allocated according to a subchannel allocation scheme selected by the BS based on a level of frequency selectivity of an unused idle frequency band from among an Adaptive Modulation and Coding (AMC) subchannel allocation scheme in which a subchannel comprising at least one bin comprising a first plurality of continuous subcarriers in a frequency domain is allocated and a diversity subchannel allocation scheme in which a subchannel comprising a second plurality of scattered subcarriers in the frequency domain is allocated; and a communication unit communicating with the BS using the allocated subchannel based on the received information on the allocated subchannel.

The apparatus may further comprise a channel state information (CSI) transmitter receiving a request from the BS for CSI comprising information on a channel state of each band if the selected subchannel allocation scheme is the band-type AMC subchannel allocation scheme or information on a channel state of each group if the selected subchannel allocation scheme is the scattered AMC subchannel allocation scheme, detecting a channel state of each band or each group, and transmitting CSI containing the detected channel states to the BS, wherein the allocated subchannel is a subchannel having a good channel state, which is selected by the BS based on the CSI.

The apparatus may further comprise a channel environment information transmitter receiving information on the idle frequency band from the BS, detecting a level of frequency selectivity of the idle frequency band, and transmitting channel environment information containing the detected level of frequency selectivity to the BS.

### ADVANTAGEOUS EFFECTS

As described above, according to the present invention, by applying a different subchannel allocation scheme according to a channel environment in a cognitive radio system efficiently using a frequency, downlink throughput can be increased.

In addition, by using a downlink frame structure, a cable/ADSL service currently provided in a wired manner and based on an OFDMA/FDD or OFDMA/TDD system in a fixed environment without mobility can be efficiently provided in a wireless manner.

In addition, by using the downlink frame structure and a dynamic resource allocation method, a multi-user diversity gain or a frequency diversity gain can be obtained, and thereby downlink efficiency can be increased.

### MODE OF THE INVENTION

The present invention will now be described more fully with reference to the accompanying drawings, in which exemplary embodiments of the invention are shown.

Various types of wireless communication technologies that have been rapidly developed are used in close proximity to each other in daily life. After Code Division Multiple Access (CDMA) communication technology called 2^{nd} generation wireless communication technology, 3d generation wireless communication technology called an International Mobile Telecommunications (IMT)-2000 system was developed so it can be used to quickly transmit data information. The IMT-2000 system was divided into the 3^{rd} Generation Partnership Project (3GPP) led by Europe and Japan and the 3GPP2 led by the United States after establishment of a single standardization draft failed. The 3GPP group has been developing an asynchronous Wideband CDMA (WCDMA) system based on the Global System for Mobile Communications (GSM), and the 3GPP2 group has been developing a CDMA-2000 system developed from an Interim Standard (IS)-95 synchronous method. However, since it is difficult to provide a data rate of 2 Mbps, which is desired to provide the IMT-2000 system, with these technologies, the technologies are limited to a packet-based multimedia service, and thus, separate standardization is being discussed to overcome this limitation.

The 3GPP group desires to support a data rate of a maximum of 10 Mbps in a downlink using a High Speed Downlink Packet Access (HSDPA) system. The 3GPP2 group has suggested a CDMA 1× Evolution-Data Voice (EV-DV) system to obtain a similar performance to the HSDPA system and desires to support a data rate of a maximum of 5.184 Mbps. However, with these data rates, it is limited for in use in wireless Internet, which is likely to soar in the future, and provide various services guaranteeing QoS. Thus, in order to enable high-speed packet transmission by guaranteeing a high data rate and support various multimedia services requiring QoS, System beyond IMT-2000 and 4^{th} generation mobile communication systems have been being developed. Wireless Broadband (WiBro) and next generation wireless communication systems, which transmit data more quickly than the above-described systems, desire to provide data more quickly with a lower price. In order to obtain a high data rate, which is a requirement of the 4^{th} generation mobile communication, a system in a wireless channel environment, which has a multi-path fading characteristic, must be robust, and have a burst data transmission characteristic and a high granularity characteristic according to the transition from a circuit data service to a packet data service. The rapidly developing wireless communication systems require other frequencies due to its coexistence with existing technology, but at present, most of all available frequencies are already assigned. Thus, most of a lower portion of a several GHz band is not remaining.

To solve this problem, J. Mitola suggested a concept of Cognitive Radio (CR) technology in which a frequency already assigned but currently unused is sensed and efficiently shared. This effort to realize a frequency in common use has resulted in the establishment of IEEE802.22. Project Authorization Request (PAR) was approved by the IEEE in August 2004, and a first IEEE802.22 meeting was held in November 2004. Since then, a standardization meeting has been held once every two months, and a first draft was issued in January 2006. However, the standardization schedule may be more or less delayed due to necessity of various technical discussions. A target market of IEEE802.22 is suburbs of the United States, Canada and developing countries, and IEEE802.22 desires to provide a wireless communication service using the CR technology on a TV frequency band. In terms of transmission of packet data to a fixed user, a user of IEEE802.22 is similar to a user of Worldwide Interoperability for Microwave Access (WiMax) of IEEE802.16, but in terms of target market, IEEE802.22 is different from IEEE802.16. That is, IEEE802.22 Wireless Regional Area Network (WRAN) is mainly used in an area having lower population density than that of a target area of IEEE802.16 Wireless Metropolitan Area Network (WMAN). Thus, it is predicted that IEEE802.22 cannot attract much interest from wireless terminal manufacturers and wireless communication providers since the market size of IEEE802.22 is relatively smaller than an existing market size. However, since a communication method having the new concept of CR technology is being standardized for the first time and an improved form of the CR technology can be used in conjunction with the next generation wireless communication technology, many companies are showing interest.

One advantage of IEEE 802.22 is that a frequency band currently used for broadcasting can be used. However, additional complexity of a base station (BS) for supporting the CR technology, the size of a reception antenna using a Very High Frequency (VHF) band, and quality of service (QoS) due to a frequency in common use must be considered. As described above, technologies used for CR systems are not only IEEE 802.22 but also wireless channel management, distribution, and interference detection technologies of multiple channels and have a high possibility of being used in conjunction with the next generation wireless communication technology in terms of mutual complement. For example, in a shadow area of a cellular environment or a country area with a big cell, the CR technology is an alternative for effectively transmitting high-speed data without frequency interference.

The Orthogonal Frequency Division Multiplexing (OFDM) scheme attracts attention as one of the schemes suitable for the 4^{th} generation mobile communication system due to high transmission efficiency and simple channel equalizing.

In addition the OFDM-FDMA or OFDMA scheme, which is a multi-user access scheme based on OFDM, is a multi-user access scheme for allocating different subcarriers to users and has an advantage in that various QoSs can be provided by variously assigning resources according to users' demands. The OFDMA scheme is a standard physical layer of IEEE802.16a and is selected as a wireless access method of high-speed portable Internet, which is rapidly being developed in Korea.

However, since the OFDM scheme has, up to now, mainly been applied to wired systems, such as Asymmetric Digital Subscriber Line (ADSL) and Very-high-speed Digital Subscriber Line (VDSL), and wireless systems having low mobility, such as Wireless Local Area Network (WLAN), research and development of various fields are required in order to apply the OFDM scheme to the cellular environment.

Since the OFDM scheme can compensate for inter-symbol interference rapidly increasing in high-speed transmission using a simple single-tap equalizer having high frequency efficiency and can be implemented so as to have a high data rate using a fast Fourier transform (FFT), the OFDM scheme has been recently selected as a transmission scheme for high-speed data wireless communication in WLAN, Digital Audio Broadcasting (DAB), Digital Video Broadcasting (DVB), ADSL, VDSL, and the like. However, to use the OFDM scheme in the cellular environment, various research must be carried out. In particular, research into cell-scheduling so as to increase coverage of an OFDMA cellular system and research into resource allocation algorithms so as to increase cell capacity by efficiently managing wireless resources is required. In addition, research into link application schemes, such as dynamic channel allocation, adaptive modulation, and dynamic power allocation using users' channel information, is required. An important characteristic in order to determine the performance of an OFDMA-based system in the cellular environment is a frequency reuse factor. A frequency reuse factor of 1 is most ideal in terms of BS efficiency, since a BS can use all the wireless resources. However, in this case, a severe performance decrease occurs due to inter-cell interference.

Thus, a Flash-OFDM system, which has been developed by Flarion Technologies Inc. in order to solve the performance decrease due to inter-cell interference and realize the frequency reuse factor of 1, uses a frequency hopping method of changing OFDM subcarriers with a constant pattern and a method of preventing as much as possible a performance decrease due to inter-cell interference using Low Density Parity Check (LDPC) channel code. Also, a method of randomly puncturing subcarriers so as to reduce collision with subcarriers of an adjacent cell is being developed to realize the frequency reuse factor of 1.

However, in a system maintaining the frequency reuse factor of 1, a performance decrease in a cell boundary in which a channel condition is bad due to the inter-cell interference is predicted according to an increase of traffic load. Thus, as a method for reducing the inter-cell interference, increasing frequency efficiency, and guaranteeing the performance for a user located in an area in which a channel condition is bad, such as a cell boundary, interest in a wireless resource allocation method for effectively using limited wireless resources is increasing.

If it is assumed that channels are stationary and a transmitter end correctly knows a user's channel response, it has been determined that a method of combining a water-filling scheme and an adaptive modulation scheme is optimal. However, the water-filling scheme has been mainly studied for only single-user systems and multi-user systems using a fixed resource allocation method. For example a system using Time Division Multiple Access (TDMA) or FDMA allocates a predetermined time slot or frequency channel to each user and applies the adaptive modulation scheme to channels belonging to the users. However, due to the multi-user OFDM scheme to which the adaptive modulation scheme is applied based on the fixed resource allocation method, the optimal resource allocation that a system can provide cannot be performed. The reason for this is because many unused channels exist by using a water-filling algorithm since subchannels suffering deep fading or subchannels to which inadequate power is allocated exist according to a frequency selective channel characteristic.

However, a channel through which a user suffers deep fading may not be a deep fading channel to another user, and in general, if the number of users increases, a probability that each subchannel forming OFDM is a deep fading channel to all users is gradually reduced. That is, if the number of users increases, an independent channel can be provided to the users, and thus a multi-user diversity gain can be obtained.

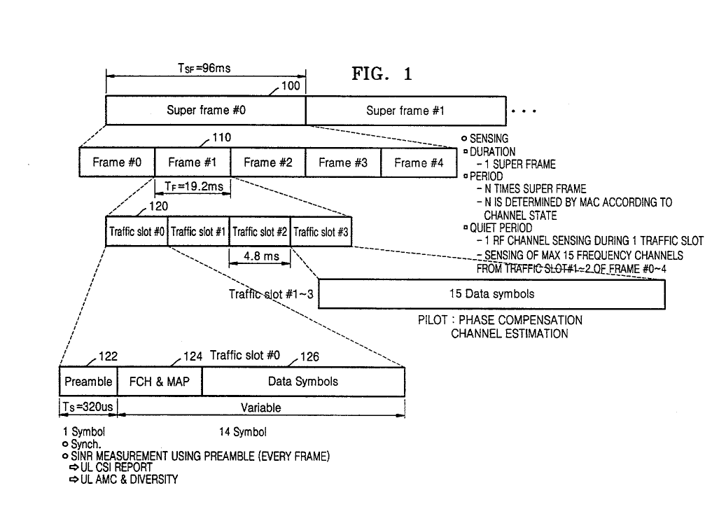

FIG. 1 illustrates an OFDMA/Frequency Division Duplexing (FDD) (or Time Division Duplexing (TDD))-based downlink frame structure according to an embodiment of the present invention.

Referring to FIG. 1, the downlink frame structure is comprised of super frames 100, frames 110, and slots 120.

Each slot 120 is made up of a plurality of OFDM symbols. In particular, according to the current embodiment, each slot 120 is made up of 15 OFDM symbols and has a length of time of 4.8 msec. A first slot 120 of each frame 110 is made up of one preamble 122, a Frame Control Header (FCH) & MAP message 124, which varies according to the number of users, and data symbols 126. Channel estimation and phase compensation using pilot subcarriers existing in a data symbol duration are performed on a slot basis.

Each frame 110 has a length of time according to a period of time for performing Signal to Interference and Noise Ratio (SINR) measurement of a terminal and dynamic resource allocation of a BS and includes a plurality of slots 120. According to the current embodiment, each frame 110 is made up of 4 slots 120 and has a length of time of 19.2 msec. Each user measures an SINR value of each subchannel using the preamble 122 on a frame basis, information on the measured SINR value is fed back to the BS, and the BS performs the dynamic resource allocation based on the information. Since an environment considered in the present invention is a fixed environment without mobility, it is assumed that a channel for each terminal hardly changes in the time domain, and it is assumed that in order to distinguish best, medium, and worst channel environments to be described later, when each terminal measures a variance value of a channel response magnitude every time the terminal is turned on and transmits the measured result to a BS, the BS stores the received result of measurement in a database (DB).

Each super frame 100 has a length of time according to a period of time for performing spectrum sensing and includes a plurality of frames 110. According to the current embodiment, each super frame 100 is made up of 5 frames 110 and has a length of time of 96 msec. The spectrum sensing period is N times the super frame 100, and it is assumed that MAC controls the N value if necessary. According to the current embodiment, if it is assumed that a BS performs the spectrum sensing for one RF channel during one slot 120, the BS can perform the spectrum sensing for 15 different RF channels using 15 combinations of 4 slots 120 without an overhead. The overhead is, for example, the preamble 122 and the FCH & MAP message 124.

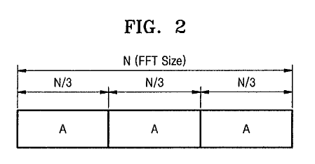

FIG. 2 illustrates a temporal characteristic of the preamble 122 illustrated in FIG. 1, according to an embodiment of the present invention. Referring to FIG. 2, the preamble 122 is repeated three times in the time domain, and a terminal performs symbol timing offset estimation, carrier frequency offset estimation, and cell identification (ID) estimation using the repetition pattern. The three-times repetition structure is obtained by properly inserting preamble sequences and nulls into subcarriers of an OFDM symbol forming the preamble 122. In detail, the repetition structure is obtained using a method of inserting a preamble sequence into each subcarrier existing in a period of once every three subcarriers and inserting nulls into the remaining subcarriers. According to the method, each receiver end can obtain an efficient synchronization performance with a simple structure without computation complexity.

Each terminal measures a channel state, such as a mean SINR, using the preamble 122 and feeds back channel state information (CSI) to a BS. The BS determines a suggested subchannel allocation method based on the fed-back CSI.

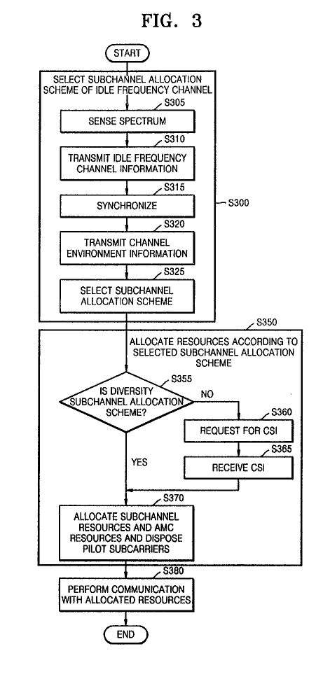

FIG. 3 is a flowchart illustrating a dynamic resource allocation method in an OFDMA-based CR system according to an embodiment of the present invention.

Referring to FIG. 3, in operation S300, a BS selects one of an Adaptive Modulation and Coding (AMC) subchannel allocation scheme, in which a subchannel comprising at least one bin (the bin comprises a first plurality of continuous subcarriers in a frequency domain) is allocated, and a diversity subchannel allocation scheme, in which a subchannel comprising a second plurality of scattered subcarriers in the frequency domain is allocated, according to the level of frequency selectivity of an unused idle frequency band.

When the AMC subchannel allocation scheme is used, a method of variously setting the first plurality according to the level of frequency selectivity of the idle frequency band can be used. In the present specification, it is determined according to the level of frequency selectivity whether a current channel environment is a best channel environment, a medium channel environment, or a worst channel environment, and one of three subchannel allocation schemes, i.e., a band-type AMC subchannel allocation scheme, a scattered AMC subchannel allocation scheme, and a diversity subchannel allocation scheme, is applied according to the level of frequency selectivity. That is, according to the current embodiment, the AMC subchannel allocation scheme includes the band-type AMC subchannel allocation scheme in which a subchannel is allocated with a band made up of M continuous bins (where M is a natural number equal to or greater than 2) in the frequency domain and the scattered AMC subchannel allocation scheme in which a subchannel is allocated with a single bin or at least two bins regardless of continuity in the frequency domain.

In detail, operation S300 includes sensing an RF channel (operation S305), transmitting information on an idle frequency band (operation S310), synchronizing (operation S315), transmitting CSI (operation S320), and selecting a subchannel allocation scheme (operation S325).

In operation S305, the BS detects a currently unused idle frequency band using various spectrum sensing algorithms. In operation S310, the BS broadcasts information on the detected idle frequency band. In operation S315, when a terminal is turned on, the terminal performs synchronization with the BS.

In operation S320, the terminal calculates a level of frequency selectivity of the broadcasted idle frequency band and transmits CSI, which is information on the level of frequency selectivity of the idle frequency band, to the BS. In order to indicate the calculated level of frequency selectivity, a variance value of a channel frequency response magnitude, i.e., a magnitude variance value, can be used.

In operation S325, the BS selects a subchannel allocation scheme that is to be applied to the idle frequency band based on the received CSI. According to the current embodiment using the three subchannel allocation schemes, in operation S325, the BS selects the band-type AMC subchannel allocation scheme if the idle frequency band belongs to the best channel environment in which the level of frequency selectivity is less than a first threshold, the scattered AMC subchannel allocation scheme if the idle frequency band belongs to the medium channel environment in which the level of frequency selectivity is equal to or greater than the first threshold and less than a second threshold, and the diversity subchannel allocation scheme if the idle frequency band belongs to the worst channel environment in which the level of frequency selectivity is equal to or greater than the second threshold.

In operation S350, the BS allocates at least one subchannel to the terminal according to the selected subchannel allocation scheme. In detail, operation S350 includes determining whether the selected subchannel allocation scheme is the AMC subchannel allocation scheme (operation S355), requesting the terminal for mean SINR information of each subchannel (operation S360), receiving the mean SINR information from the terminal (operation S365), and allocating dynamic resources (operation S370).

If it is determined in operation S355 that the subchannel allocation scheme selected in operation S325 by the BS is the AMC subchannel allocation scheme, the process proceeds to operation S360, and if it is determined in operation S355 that the subchannel allocation scheme selected in operation S325 by the BS is the diversity subchannel allocation scheme, the process proceeds to operation S370. In operation S360, the BS requests the terminal for CSI according to the AMC subchannel allocation scheme, and the terminal calculates a channel state of each subchannel and transmits CSI containing the calculated channel state of each subchannel to the BS. The CSI is information on channel states for dynamic resource allocation, wherein various CSI feedback methods exist. That is, the CSI can include information about channel states of all subchannels forming the idle frequency band or a predetermined number of subchannels having a good channel state. As an example of the channel state, a mean SINR can be used but is not limited to this.

In operation S365, the BS receives the CSI from the terminal. In operation S370, the BS allocates at least one arbitrary subchannel of the idle frequency band to the terminal if the selected subchannel allocation scheme is the diversity subchannel allocation scheme, and allocates a subchannel having a good channel state among the idle frequency band to the terminal if the selected subchannel allocation scheme is the AMC subchannel allocation scheme. In operation 370, the BS allocates resources according to AMC to the terminal based on the CSI.

Operation S350 in which the three subchannel allocation schemes are applied will now be described in detail. If it is determined in operation S355 that the subchannel allocation scheme selected in operation S325 by the BS is the band-type AMC subchannel allocation scheme or the scattered AMC subchannel allocation scheme, the process proceeds to operation S360, and if it is determined in operation S355 that the subchannel allocation scheme selected in operation S325 by the BS is the diversity subchannel allocation scheme, the process proceeds to operation S370.

In operation S360, the BS requests the terminal for CSI (the CSI is information on a channel state of each band if the selected subchannel allocation scheme is the band-type AMC subchannel allocation scheme and is information on a channel state of each group if the selected subchannel allocation scheme is the scattered AMC subchannel allocation scheme), and the terminal detects a channel state of each band or a channel state of each group and transmits CSI, which is information on the detected channel states, to the BS. The channel state of each group indicates a channel state of a plurality of continuous bins in the frequency domain.

In operation S365, the BS receives the CSI from the terminal. In operation S370, the BS allocates at least one arbitrary subchannel of the idle frequency band to the terminal if the selected subchannel allocation scheme is the diversity subchannel allocation scheme, allocates at least one band having a good channel state among the idle frequency band to the terminal if the selected subchannel allocation scheme is the band-type AMC subchannel allocation scheme, allocates at least one bin having a good channel state among the idle frequency band to the terminal if the selected subchannel allocation scheme is the scattered AMC subchannel allocation scheme. In operation 370, the BS allocates resources according to AMC to the terminal based on the CSI. In particular, when the AMC resources are dynamically allocated in the diversity subchannel allocation scheme, in operation 360 or 370, the BS requests the terminal for CSI, receives the CSI, and dynamically allocates the AMC resources based on the CSI. As an example of information containing the CSI used in the diversity subchannel allocation scheme, a channel state, such as a mean SINR of the entire band of the idle frequency band, can be used, and thereby, overhead can be reduced.

If the terminal provides CSI comprising only an identification (ID) of a predetermined number of bands or groups having a good channel state among bands or groups belonging to the idle frequency band and a channel state corresponding to the ID to the BS in operation S360, in operation S370, the BS selects a subchannel belonging to a band or group having a good channel state from among the predetermined number of bands or groups based on the CSI and allocates the selected subchannel to the terminal.

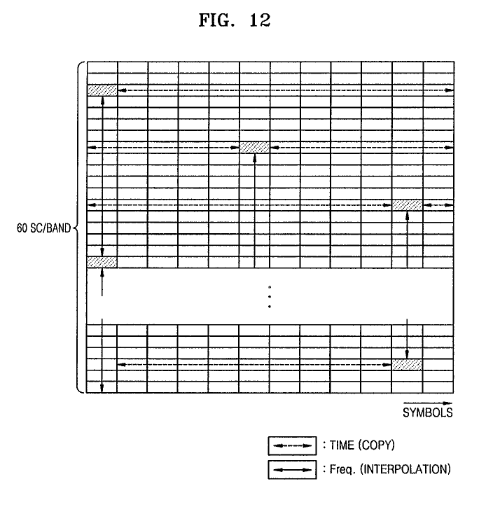

In operation S370, pilot subcarriers are disposed in the idle frequency band, by the BS, and these pilot subcarriers allow the terminal to perform channel estimation. An example of a pilot disposing method will now be described. The BS disposes one pilot subcarrier at N_{f} subcarrier intervals in each pilot OFDM symbol (the pilot OFDM symbol comprises at least one pilot subcarrier and exists in a period of Nₜ OFDM symbol intervals) in which the pilot subcarriers are disposed by applying a different offset to each of K adjacent pilot OFDM symbols so that positions of the pilot subcarriers in the frequency domain are not the same as those between the K adjacent pilot OFDM symbols. Here, N_{f} of the AMC subchannel allocation scheme may be greater than N_{f} of the diversity subchannel allocation scheme. The pilot disposing method will be described in more detail with reference to FIGS. 12 through 14 later.

In operation S380, the terminal communicates with the allocated resources. An example of the allocated resources can be subchannel resources and AMC resources. Channel estimation is required when the terminal performs communication, wherein the channel estimation is basically performed using received pilot OFDM symbols included in a received signal according to a downlink frame. A channel estimation method of a case where the three subchannel allocation schemes are used will now be described. The terminal copies, in the time domain, a reception value of pilot subcarriers contained in received pilot OFDM symbols included in a received signal according to the downlink frame and performs interpolation in the frequency domain, wherein if the selected subchannel allocation scheme is the band-type AMC subchannel allocation scheme, the scattered AMC subchannel allocation scheme, or the diversity subchannel allocation scheme, the channel estimation is performed by performing the interpolation in the frequency domain in a band basis, a bin basis, or an entire band basis. The channel estimation method will be described in more detail with reference to FIGS. 12 through 14 later.

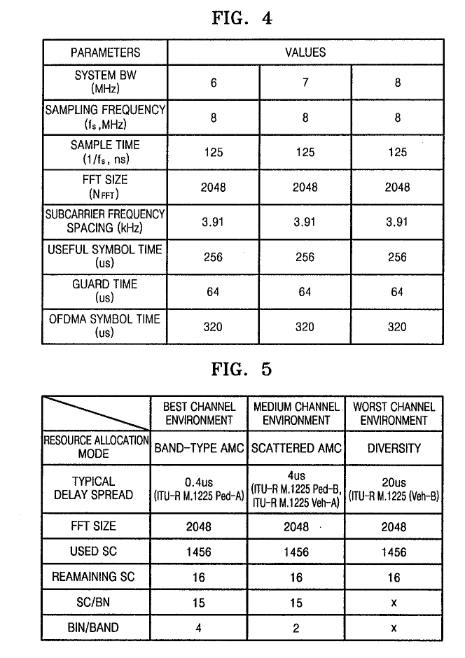

FIG. 4 illustrates system parameters used in an OFDMA-based cognitive radio system according to an embodiment of the present invention. In detail, at able illustrated in FIG. 4 shows system parameters used in FIG. 1.

FIG. 4 shows system parameters of each of the system bandwidths 6, 7, and 8 MHz when 35 μsec, according to a profile C of a WRAN channel, is set as the maximum delay spread.

FIG. 5 is a table for describing the three subchannel allocation schemes according to another embodiment of the present invention. Referring to FIG. 5, the three subchannel allocation schemes are the diversity subchannel allocation scheme, the band-type AMC subchannel allocation scheme, and the scattered AMC subchannel allocation scheme, wherein the band-type AMC subchannel allocation scheme and the scattered AMC subchannel allocation scheme belong to the AMC subchannel allocation scheme. A BS can determine a channel type of an idle frequency band as one of a best channel, a medium channel, and a worst channel according to a level of frequency selectivity, wherein the best channel, the medium channel, and the worst channel respectively correspond to the band-type AMC subchannel allocation scheme, the scattered AMC subchannel allocation scheme, and the diversity subchannel allocation scheme. An example of a measurement corresponding to the level of frequency selectivity can be a magnitude variance value. That is, based on a magnitude variance value of a current idle frequency band, the BS selects the band-type AMC subchannel allocation scheme in operation S325, illustrated in FIG. 3, if the BS determines a channel type of the current idle frequency band as the best channel, selects the scattered AMC subchannel allocation scheme in operation S325 if the BS determines the channel type of the current idle frequency band as the medium channel, and selects the diversity subchannel allocation scheme in operation S325 if the BS determines the channel type of the current idle frequency band as the worst channel. The 16 remaining subcarriers are used to transmit a broadcast & multicast message.

FIG. 6 illustrates a channel spectrum, which can be considered as the best channel illustrated in FIG. 5. In detail, FIG. 6 illustrates a channel variation in an ITU-R M.1225 Ped-A 3 km/h environment illustrated in FIG. 5. As illustrated in FIG. 6, a variation of channel response values is small in 60 continuous subcarriers, i.e., a channel response value is slowly changed in the frequency domain.

As a result, the channel spectrum is considered as the best channel, and thus the band-type AMC subchannel allocation scheme is selected. Since the amount of CSI to be fed back to the BS is small due to a small amount of the variation of channel response values, dynamic subchannel allocation can be performed.

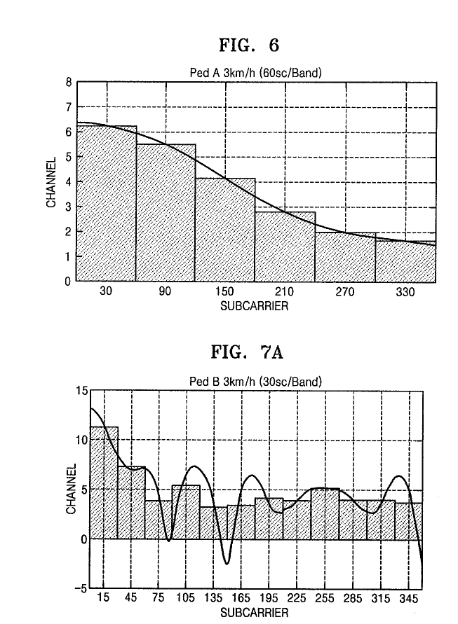

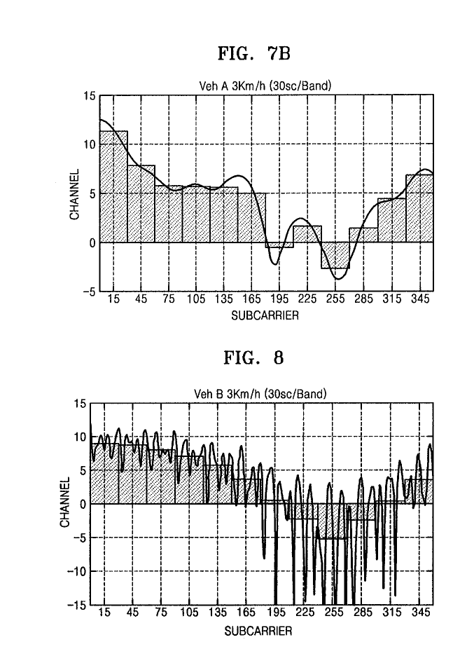

FIGS. 7A and 7B illustrate channel spectra, which can be considered as the medium channel illustrated in FIG. 5. In detail, FIGS. 7A and 7B respectively illustrate a channel variation in an ITU-R M.1225 Ped-B 3 km/h environment and a channel variation in an ITU-R M.1225 Veh-A 3 km/h environment. Channels illustrated in FIGS. 7A and 7B vary more quickly than the channel illustrated in FIG. 6 in the frequency domain. This indicates that the ITU-R M.1225 Ped-B 3 km/h environment and the ITU-R M.1225 Veh-A 3 km/h environment are more frequency selective than the ITU-R M.1225 Ped-A 3 km/h environment. However, since a channel variation in the frequency domain is small for 30 continuous subcarriers, dynamic subchannel allocation can be performed as in the band-type AMC subchannel allocation scheme. Thus, the channels illustrated in FIGS. 7A and 7B are considered as the medium channel, and the scattered AMC subchannel allocation scheme is selected.

FIG. 8 illustrates a channel spectrum, which can be considered as the worst channel illustrated in FIG. 5. In detail, FIG. 8 illustrates a channel variation in an ITU-R M.1225 Veh-B 3 km/h environment illustrated in FIG. 5. As illustrated in FIG. 8, a channel response value varies very quickly in the frequency domain. In this case, in order to perform dynamic subchannel allocation, a great amount of CSI must be fed back to the BS, resulting in a decrease in system capacity, and thus, it is difficult to apply dynamic subchannel allocation as illustrated in FIGS. 6 and 7. Thus, the channel spectrum is considered as the worst channel, and the diversity subchannel allocation scheme performing random allocation is selected.

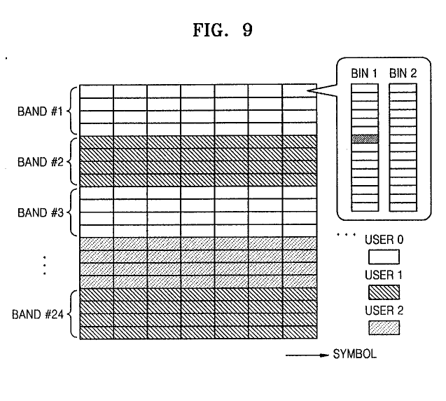

FIG. 9 is a diagram for describing the band-type AMC subchannel allocation scheme according to an embodiment of the present invention. A set of a plurality of continuous subcarriers is called a bin, and according to the current embodiment, each bin includes 15 continuous subcarriers. Bins existing in the time/frequency domain belong to one of two types of bins, i.e., bin1 and bin2. Bin1 includes one pilot subcarrier for channel estimation and 14 data subcarriers, and bin2 includes 15 data subcarriers. According to the current embodiment, 4 continuous bins in the frequency domain form a single band, and a total of 24 bands exist. That is, a single band includes 60 subcarriers. Each band is a subchannel of the band-type AMC subchannel allocation scheme. In operation S360 illustrated in FIG. 3, the terminal feeds back information on a mean SINR value of each band during a single frame to the BS to which the terminal belongs. In operation S370 illustrated in FIG. 3, the BS can obtain a multi-user diversity gain and an implicit frequency diversity gain by allocating at least one subchannel having a good mean SINR value to the terminal based on the fed-back information, and as a result, system efficiency and frequency efficiency can be obtained.

FIG. 10 is a diagram for describing the scattered AMC subchannel allocation scheme according to an embodiment of the present invention. Referring to FIG. 10, the bin structure is the same as that illustrated in FIG. 9. However, 2 continuous bins in the frequency domain form a single band, and thus, a total of 48 bands exist. In the present specification, in order to distinguish from a band of the band-type AMC subchannel allocation scheme, a band of the scattered AMC subchannel allocation scheme is called a group for convenience of description. Since the channels illustrated in FIGS. 7A and 7B vary more quickly than the channel illustrated in FIG. 6 in the frequency domain, it is preferable that the ban d-type AMC subchannel allocation scheme illustrated in FIG. 9 not be applied, and thus, each bin is allocated to a single terminal as illustrated in FIG. 10. In operation S360 illustrated in FIG. 3, the terminal feeds back information on a mean SINR value of each group during a single frame to the BS to which the terminal belongs. In operation S370 illustrated in FIG. 3, the BS can obtain a multi-user diversity gain and an implicit frequency diversity gain by allocating at least one bin having a good mean SINR value to the terminal based on the fed-back information, and as a result, system efficiency and frequency efficiency can be achieved.

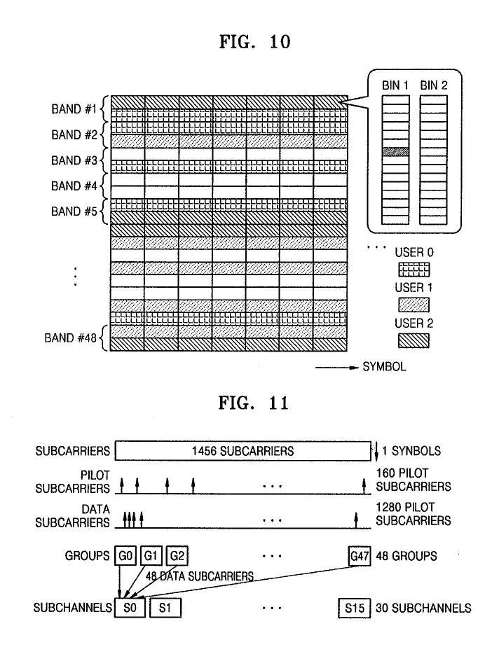

FIG. 11 is a diagram for describing the diversity subchannel allocation scheme according to an embodiment of the present invention. Referring to FIG. 11, 160 pilot subcarriers having a fixed position exist in the frequency domain, and 48 groups exist, wherein each group includes 30 continuous subcarriers. Each diversity subchannel is formed of 48 subcarriers obtained by selecting one from each of the 48 groups, and as a result, 30 diversity subchannels, S0 through S29, exist.

FIG. 12 is a diagram for describing channel estimation in the band type AMC subchannel allocation scheme according to an embodiment of the present invention. A pilot subcarrier is iteratively disposed in the third, eighth, and thirteenth positions of a bin of every symbol located in a period of 5 symbols in the time domain. Since a channel variation hardly occurs in the time domain due to a fixed environment, in operation S380 illustrated in FIG. 3, the terminal performs the channel estimation by copying a reception value of pilot subcarriers in the time domain and performing interpolation on a band basis in the frequency domain. A pilot disposing method according to the current embodiment can be adaptively changed according to a channel state, and the channel estimation can be performed using only a preamble without a pilot according to the channel environment.

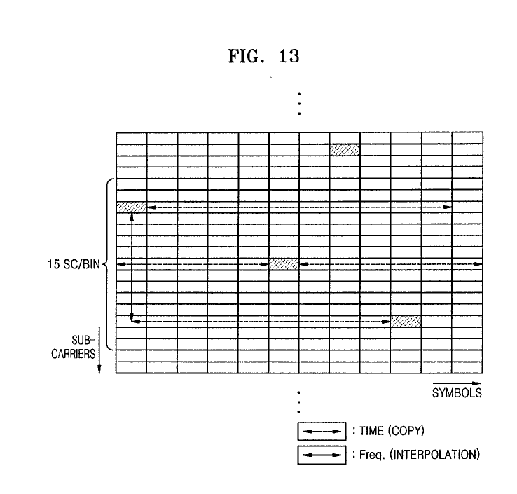

FIG. 13 is a diagram for describing channel estimation in the scattered AMC subchannel allocation scheme according to an embodiment of the present invention. A pilot disposing method according to the current embodiment is the same as the pilot disposing method illustrated in FIG. 12. However, in operation S380 illustrated in FIG. 3, the terminal performs interpolation on a bin basis, instead of a band basis, in the frequency domain.

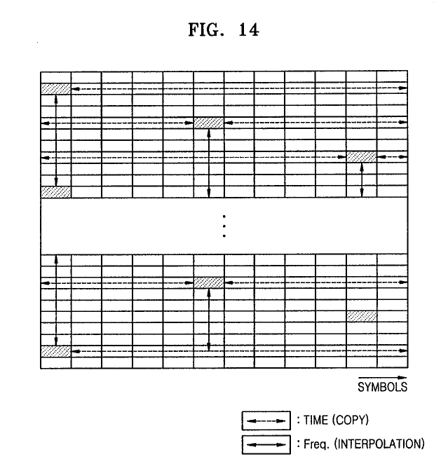

FIG. 14 is a diagram for describing channel estimation in the diversity sub channel allocation scheme according to an embodiment of the present invention.

A pilot disposing method according to the current embodiment is similar to the pilot disposing methods illustrated in FIGS. 12 and 13, wherein a frequency interval is an interval of 9 subcarriers instead of 15 subcarriers.

Since there is barely any channel variation in the time domain due to a fixed environment, the channel estimation is performed by performing copying in the time domain and performing interpolation in the frequency domain. That is, in operation S380 illustrated in FIG. 3, the terminal performs the channel estimation by copying a reception value of pilot subcarriers in the time domain and performing interpolation on an entire band basis in the frequency domain.

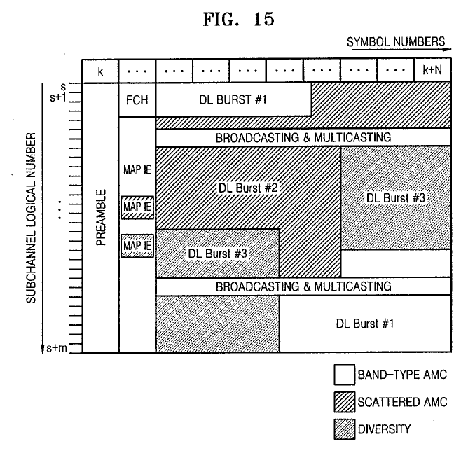

FIG. 15 illustrates a subchannel allocation structure for an OFDMA/FDD-based cognitive radio system according to an embodiment of the present invention. Referring to FIG. 15, the subchannel allocation structure includes a control channel, band-type AMC subchannels, scattered AMC subchannels, and diversity subchannels. First, a symbol, which is a preamble for sync estimation, cell search, and SINR estimation, is transmitted, and then an FCH & MAP message is transmitted. The band-type AMC subchannels, scattered AMC subchannels, and diversity subchannels are used together, and a structure for obtaining a diversity gain by dividing a broadcast & multicast message using 16 remaining subcarriers into two parts is used.

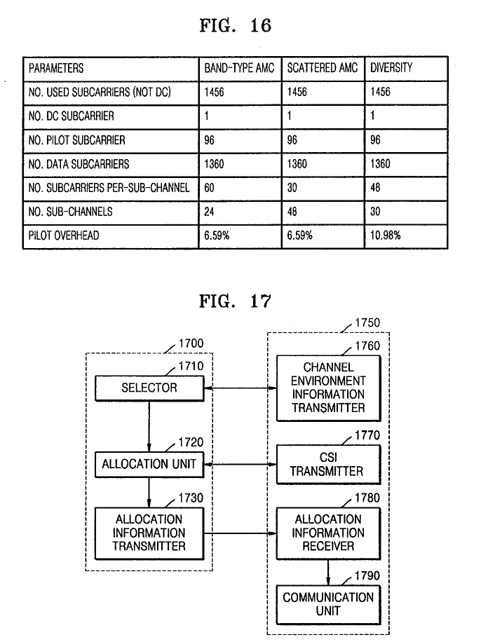

FIG. 16 illustrates parameters of data subcarriers and pilot subcarriers for the subchannel allocation schemes according to an embodiment of the present invention. Referring to FIG. 6, an overhead proportion of the diversity subchannel allocation scheme is higher by around 4.38% than that of the band-type AMC subchannel allocation scheme or the scattered AMC subchannel allocation scheme. Since a channel environment in which the diversity subchannel allocation scheme is used varies very quickly in the frequency domain, more pilot subcarriers than those required in the band-type AMC subchannel allocation scheme or the scattered AMC subchannel allocation scheme are required in order to estimate a channel.

FIG. 17 is a block diagram of apparatuses of a BS and a terminal for performing dynamic resource allocation in an OFDMA-based cognitive radio system according to an embodiment of the present invention.

Referring to FIG. 17, reference numeral 1700 denotes a dynamic resource allocation apparatus included in the BS, and reference numeral 1750 denotes a dynamic resource allocation apparatus included in the terminal, which receives dynamically allocated resources.

The dynamic resource allocation apparatus 1700 included in the BS includes a selector 1710, an allocation unit 1720, and an allocation information transmitter 1730. The dynamic resource allocation apparatus 1750 included in the terminal includes a channel environment information transmitter 1760, a CSI transmitter 1770, an allocation information receiver 1780, and a communication unit 1790.

The selector 1710 selects one of the AMC subchannel allocation scheme, in which a subchannel containing at least one bin comprising a first plurality of continuous subcarriers in the frequency domain is allocated, and the diversity subchannel allocation scheme, in which a subchannel containing a second plurality of scattered subcarriers in the frequency domain is allocated, according to a level of frequency selectivity of an unused idle frequency band. According to the current embodiment, the selector 1710 obtains information on the level of frequency selectivity of an unused idle frequency band by requesting it from the channel environment information transmitter 1760. The AMC subchannel allocation scheme includes the band-type AMC subchannel allocation scheme in which the subchannel is allocated with a band made up of M continuous bins in the frequency domain, where M is a natural number equal to or greater than 2, and the scattered AMC subchannel allocation scheme, in which the subchannel is allocated with a single bin or at least two bins regardless of continuity in the frequency domain, wherein the selector 1710 selects the band-type AMC subchannel allocation scheme if the idle frequency band belongs to a best channel environment, in which the level of frequency selectivity is less than a first threshold, selects the scattered AMC subchannel allocation scheme if the idle frequency band belongs to a medium channel environment, in which the level of frequency selectivity is equal to or greater than the first threshold and less than a second threshold, or selects the diversity subchannel allocation scheme if the idle frequency band belongs to a worst channel environment, in which the level of frequency selectivity is equal to or greater than the second threshold.

The allocation unit 1720 allocates at least one subchannel to the terminal according to the selected subchannel allocation scheme. The allocation information transmitter 1730 transmits information on the allocated subchannel to the terminal.

The channel environment information transmitter 1760 receives information on the idle frequency band from the BS, detects a level of frequency selectivity of the idle frequency band, and transmits channel environment information containing the detected level of frequency selectivity to the selector 1710.

The CSI transmitter 1770 receives a request from the BS for CSI containing information on a channel state of each band if the selected subchannel allocation scheme is the band-type AMC subchannel allocation scheme or information on a channel state of each group if the selected subchannel allocation scheme is the scattered AMC subchannel allocation scheme, detects a channel state of each band or each group, and transmits CSI containing information on the detected channel states to the allocation unit 1720.

The allocation information receiver 1780 receives, from the allocation information transmitter 1730, information on a subchannel allocated according to a subchannel allocation scheme selected by the BS based on a level of frequency selectivity of a currently unused idle frequency band from among the AMC subchannel allocation scheme, in which a subchannel containing at least one bin comprising a first plurality of continuous subcarriers in a frequency domain is allocated, and the diversity subchannel allocation scheme, in which a subchannel containing a second plurality of scattered subcarriers in the frequency domain is allocated.

The communication unit 1790 communicates with the BS using the allocated subchannel based on the received information on the allocated subchannel.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and detail may be made the rein without departing from the spirit and scope of the present invention as defined by the following claims.

1. A dynamic resource allocation method used by a base station (BS) to allocate a subchannel to a terminal in an Orthogonal Frequency Division Multiple Access (OFDMA)-based cognitive radio system, the method comprising:
the BS selecting one of an Adaptive Modulation and Coding (AMC) subchannel allocation scheme, in which a subchannel comprising at least one bin comprising a first plurality of continuous subcarriers in a frequency domain is allocated, and a diversity subchannel allocation scheme, in which a subchannel comprising a second plurality of scattered subcarriers in the frequency domain is allocated, according to a level of frequency selectivity of an unused idle frequency band; and
the BS allocating at least one subchannel to the terminal according to the selected subchannel allocation scheme.

2. The method of claim 1, wherein the AMC subchannel allocation scheme comprises a band-type AMC subchannel allocation scheme in which the subchannel is allocated with a band made up of M continuous bins in the frequency domain, where M is a natural number equal to or greater than 2, and a scattered AMC subchannel allocation scheme in which the subchannel is allocated with a single bin or at least two bins regardless of continuity in the frequency domain,
wherein the selecting comprises the BS selecting the band-type AMC subchannel allocation scheme if the idle frequency band belongs to a best channel environment, in which the level of frequency selectivity is less than a first threshold, selecting the scattered AMC subchannel allocation scheme if the idle frequency band belongs to a medium channel environment, in which the level of frequency selectivity is equal to or greater than the first threshold and less than a second threshold, and selecting the diversity subchannel allocation scheme if the idle frequency band belongs to a worst channel environment, in which the level of frequency selectivity is equal to or greater than the second threshold.

3. The method of claim 1, wherein the allocating comprises the BS allocating a subchannel to the terminal based on a channel state of each subchannel of the idle frequency band if the selected subchannel allocation scheme is the AMC subchannel allocation scheme.

4. The method of claim 2, wherein the allocating comprises the BS allocating a subchannel to the terminal based on a channel state of each subchannel of the idle frequency band if the selected subchannel allocation scheme is the band-type AMC subchannel allocation scheme, and allocating a subchannel to the terminal based on a channel state of each group comprising a predetermined plurality of continuous bins in the frequency domain if the selected subchannel allocation scheme is the scattered AMC subchannel allocation scheme.

5. The method of claim 4, wherein the band comprises 4 bins, and the group comprises 2 bins, wherein the bin comprises 15 data subcarriers, or 14 data subcarriers and one pilot subcarrier.

6. The method of claim 1, wherein the diversity subchannel allocation scheme is a subchannel allocation scheme generating J subchannels, in which K groups, each group comprising J continuous subcarriers in the frequency domain, are generated by grouping subcarriers belonging to the idle frequency band, and each subchannel is generated with subcarriers obtained by selecting one subcarrier from each group.

7. The method of claim 6, wherein J is 30, and K is 48.

8. The method of claim 2, wherein the allocating comprises the BS allocating an arbitrary subchannel to the terminal if the selected subchannel allocation scheme is the diversity subchannel allocation scheme.

9. The method of claim 4, wherein the allocating comprises:
the BS requesting the terminal for channel state information (CSI) comprising information on a channel state of each band if the selected subchannel allocation scheme is the band-type AMC subchannel allocation scheme and information on a channel state of each group if the selected subchannel allocation scheme is the scattered AMC subchannel allocation scheme, and obtaining the CSI from the terminal; and
the BS selecting a subchannel having a good channel state based on the CSI and allocating the selected subchannel to the terminal.

10. The method of claim 3 or 4, wherein the channel state is a mean Signal to Interference and Noise Ratio (SINR) of the terminal.

11. The method of claim 9, wherein the CSI comprises an identification (ID) of a predetermined number of bands or groups having a good channel state among bands or groups belonging to the idle frequency band and a channel state corresponding to the ID,
wherein the allocating comprises the BS selecting a subchannel belonging to a band or group having a good channel state from among the predetermined number of bands or groups based on the CSI and allocating the selected subchannel to the terminal.

12. The method of claim 1 or 2, wherein the allocating further comprises the BS allocating resources according to the AMC based on the channel state of each subchannel of the idle frequency band if the selected subchannel allocation scheme is the AMC subchannel allocation scheme.

13. The method of claim 9, wherein the allocating further comprises the BS allocating resources according to the AMC based on the CSI if the selected subchannel allocation scheme is the AMC subchannel allocation scheme.

14. The method of claim 1 or 2, wherein the allocating further comprises the BS allocating resources according to the AMC based on a channel state of the entire band of the idle frequency band if the selected subchannel allocation scheme is the diversity subchannel allocation scheme.

15. The method of claim 14, wherein the channel state is a mean SINR of the terminal.

16. The method of claim 14, wherein the allocating comprises:
if the selected subchannel allocation scheme is the diversity subchannel allocation scheme, the BS requesting the terminal for CSI comprising information on the channel state of the entire band of the idle frequency band, and obtaining the CSI from the terminal; and
the BS allocating resources according to the AMC based on the CSI.

17. The method of claim 1, wherein the selecting comprises:
the BS transmitting information of the idle frequency band to the terminal;
the BS receiving channel environment information comprising information on the level of frequency selectivity of the idle frequency band from the terminal; and
the BS selecting one of the AMC subchannel allocation scheme and the diversity subchannel allocation scheme based on the received channel environment information.

18. The method of claim 17, wherein the channel environment information contains a variance value of a channel frequency response magnitude of the idle frequency band, which is calculated by the terminal.

19. The method of claim 1, wherein a downlink frame transmitted between the BS and the terminal comprises:
a slot comprising a first plurality of OFDM symbols;
a frame, which has a first length of time according to a period of time for performing channel state measurement of a terminal and dynamic resource allocation of a BS and comprises a second plurality of slots; and
a super frame having a second length of time and comprising a third plurality of frames.

20. The method of claim 19, further comprising the BS detecting the idle frequency band by sensing a spectrum in a period of time N times the super frame.

21. The method of claim 20, wherein N is controlled by Media Access Control (MAC),
wherein the detecting comprises the BS performing spectrum sensing of a radio frequency (RF) band by an amount of a remaining slot number using slots remaining by excluding slots including an overhead according to a preamble and a Frame Control Header (FCH) & MAP message.

22. The method of claim 1, wherein the allocating comprises the BS disposing one pilot subcarrier at N_{f} subcarrier intervals in each pilot OFDM symbol comprising at least one pilot subcarrier and existing in a period of Nₜ OFDM symbol intervals, in which the pilot subcarriers are disposed by applying a different offset to each of K adjacent pilot OFDM symbols so that positions of the pilot subcarriers in the frequency domain are not the same between the K adjacent pilot OFDM symbols,
wherein N_{f} of the AMC subchannel allocation scheme is greater than N_{f} of the diversity subchannel allocation scheme.

23. The method of claim 22, wherein each bin comprises 15 subcarriers,
Nₜ is 5,
N_{f} is 15 in the AMC subchannel allocation scheme and 9 in the diversity subchannel allocation scheme,
K is 3,
the minimum interval between offsets used in the AMC subchannel allocation scheme has 5 subcarrier intervals, and
the minimum interval between offsets used in the diversity subchannel allocation scheme has 3 subcarrier intervals.

24. A downlink frame structure for dynamic resource allocation in an OFDMA-based cognitive radio system, the downlink frame structure comprising:
a slot comprising a first plurality of OFDM symbols;
a frame, which has a first length of time according to a period of time for performing channel state measurement of a terminal and dynamic resource allocation of a BS and comprises a second plurality of slots; and
a super frame having a second length of time and comprising a third plurality of frames.

25. The downlink frame structure of claim 24, wherein the second length of time is 96 msec,
the first length of time is 4.8 msec,
the third plurality is 5,
the second plurality is 4, and
the first plurality is 15.

26. The downlink frame structure of claim 24, wherein the first symbol of a frame placed at the beginning of the super frame is a preamble for performing at least one of symbol timing, offset estimation, subcarrier frequency offset estimation, cell identification (ID) estimation, channel estimation, and acquisition of CSI that is to be reported from the terminal to the BS,
wherein the preamble is repeated a predetermined number of times in a time domain.

27. The downlink frame structure of claim 24, wherein the predetermined number of times is 3.

28. A dynamic resource allocation method used by a terminal to receive a subchannel allocated by a base station (BS) in an Orthogonal Frequency Division Multiple Access (OFDMA)-based cognitive radio system, the method comprising:
an allocation information receiving process, wherein a terminal receives, from a base station (BS), information on a subchannel allocated according to a subchannel allocation scheme selected by the BS based on a level of frequency selectivity of an unused idle frequency band from among an Adaptive Modulation and Coding (AMC) subchannel allocation scheme, in which a subchannel comprising at least one bin comprising a first plurality of continuous subcarriers in a frequency domain is allocated, and a diversity subchannel allocation scheme, in which a subchannel comprising a second plurality of scattered subcarriers in the frequency domain is allocated; and
a communication process, wherein the terminal communicates with the BS using the allocated subchannel based on the received information on the allocated subchannel.

29. The method of claim 28, wherein the AMC subchannel allocation scheme comprises a band-type AMC subchannel allocation scheme, in which the subchannel is allocated with a band made up of M continuous bins in the frequency domain, where M is a natural number equal to or greater than 2, and a scattered AMC subchannel allocation scheme, in which the subchannel is allocated with a single bin or at least two bins regardless of continuity in the frequency domain,
wherein the selected subchannel allocation scheme is selected using a method of selecting the band-type AMC subchannel allocation scheme if the idle frequency band belongs to a best channel environment, in which the level of frequency selectivity is less than a first threshold, selecting the scattered AMC subchannel allocation scheme if the idle frequency band belongs to a medium channel environment, in which the level of frequency selectivity is equal to or greater than the first threshold and less than a second threshold, or selecting the diversity subchannel allocation scheme if the idle frequency band belongs to a worst channel environment, in which the level of frequency selectivity is equal to or greater than the second threshold.

30. The method of claim 28, wherein the information on the allocated subchannel is information on a subchannel allocated to the terminal based on a channel state of each subchannel of the idle frequency band if the selected subchannel allocation scheme is the AMC subchannel allocation scheme.

31. The method of claim 29, wherein the information on the allocated subchannel is information on a subchannel allocated to the terminal based on a channel state of each subchannel of the idle frequency band if the selected subchannel allocation scheme is the band-type AMC subchannel allocation scheme, or information on a subchannel allocated to the terminal based on a channel state of each group comprising a predetermined plurality of continuous bins in the frequency domain if the selected subchannel allocation scheme is the scattered AMC subchannel allocation scheme.

32. The method of claim 29, wherein the information on the allocated subchannel is information on a subchannel arbitrarily allocated to the terminal from among subchannels belonging to the idle frequency band if the selected subchannel allocation scheme is the diversity subchannel allocation scheme.

33. The method of claim 31, further comprising a transmission process, wherein the terminal receives a request from the BS for channel state information (CSI) comprising information on a channel state of each band if the selected subchannel allocation scheme is the band-type AMC subchannel allocation scheme or information on a channel state of each group if the selected subchannel allocation scheme is the scattered AMC subchannel allocation scheme, detects a channel state of each band or each group, and transmits CSI containing information on the detected channel states to the BS,
wherein the allocated subchannel is a subchannel having a good channel state, which is selected by the BS based on the CSI.

34. The method of claim 30 or 31, wherein the channel state is a mean Signal to Interference and Noise Ratio (SINR) of the terminal.

35. The method of claim 33, wherein the CSI comprises an identification (ID) of a predetermined number of bands or groups having a good channel state from among bands or groups belonging to the idle frequency band and a channel state corresponding to the ID,
wherein the allocated subchannel is a subchannel selected by the BS, which belongs to a band or group having a good channel state from among the predetermined number of bands or groups based on the CSI.

36. The method of claim 28 or 29, wherein if the selected subchannel allocation scheme is the AMC subchannel allocation scheme,
the allocation information receiving process comprises receiving information on resources allocated to the terminal by the BS according to the AMC based on the channel state of each subchannel of the idle frequency band, and
the communication process comprises communicating with the BS based on the resources allocated according to the AMC.

37. The method of claim 28 or 29, wherein if the selected subchannel allocation scheme is the diversity subchannel allocation scheme,
the allocation information receiving process comprises receiving information on resources allocated to the terminal by the BS according to the AMC based on a channel state of the entire band of the idle frequency band, and
the communication process comprises communicating with the BS based on the resources allocated according to the AMC.

38. The method of claim 37, wherein the channel state is a mean SINR of the terminal.

39. The method of claim 37, further comprising a transmission process, wherein if the selected subchannel allocation scheme is the diversity subchannel allocation scheme, the terminal receives a request from the BS for CSI comprising information on a channel state of the entire band of the idle frequency band, detects the channel state of the entire band, and transmits CSI containing information on the detected channel state to the BS.

40. The method of claim 28, further comprising:
the terminal receiving information on the idle frequency band from the BS; and
the terminal detecting a level of frequency selectivity of the idle frequency band and transmitting channel environment information containing information on the detected level of frequency selectivity to the BS.

41. The method of claim 40, wherein the channel environment information contains a variance value of a channel frequency response magnitude of the idle frequency band, which is calculated by the terminal.

42. The method of claim 28, wherein a downlink frame transmitted between the BS and the terminal comprises:
a slot comprising a first plurality of OFDM symbols;
a frame, which has a first length of time according to a period of time for performing channel state measurement of a terminal and dynamic resource allocation of a BS and comprises a second plurality of slots; and
a super frame having a second length of time and comprising a third plurality of frames.

43. The method of claim 42, wherein the super frame comprises a plurality of pilot symbols formed in a method of disposing one pilot subcarrier at N_{f} subcarrier intervals in each pilot OFDM symbol comprising at least one pilot subcarrier and existing in a period of Nₜ OFDM symbol intervals, in which the pilot subcarriers are disposed by applying a different offset to each of K adjacent pilot OFDM symbols so that positions of the pilot subcarriers in the frequency domain are not the same between the K adjacent pilot OFDM symbols,
wherein the communication process comprises the terminal performing channel estimation using received pilot OFDM symbols comprised in a received signal according to the downlink frame.

44. The method of claim 29, wherein a downlink frame transmitted between the BS and the terminal comprises:
a slot comprising a first plurality of OFDM symbols;
a frame, which has a first length of time according to a period of time for performing channel state measurement of a terminal and dynamic resource allocation of a BS and comprises a second plurality of slots; and
a super frame having a second length of time and comprising a third plurality of frames.

45. The method of claim 44, wherein the super frame comprises a plurality of pilot symbols formed in a method of disposing one pilot subcarrier at N_{f} subcarrier intervals in each pilot OFDM symbol comprising at least one pilot subcarrier and existing in a period of Nₜ OFDM symbol intervals, in which the pilot subcarriers are disposed by applying a different offset to each of K adjacent pilot OFDM symbols so that positions of the pilot subcarriers in the frequency domain are not the same between the K adjacent pilot OFDM symbols,
wherein the communication process comprises the terminal performing channel estimation by copying in a time domain a reception value of pilot subcarriers contained in received pilot OFDM symbols comprised in a received signal according to the downlink frame and performing interpolation in the frequency domain, wherein if the selected subchannel allocation scheme is the band-type AMC subchannel allocation scheme, the scattered AMC subchannel allocation scheme, or the diversity subchannel allocation scheme, the channel estimation is performed by performing the interpolation in the frequency domain on a band basis, a bin basis, or an entire band basis.

46. A computer readable recording medium storing a computer readable program for executing the method of claim 1.

47. A computer readable recording medium storing the downlink frame structure of claim 24.

48. A computer readable recording medium storing a computer readable program for executing the method of claim 28.

49. A dynamic resource allocation apparatus of a base station (BS) for allocating a subchannel to a terminal in an Orthogonal Frequency Division Multiple Access (OFDMA)-based cognitive radio system, the apparatus comprising:
a selector selecting one of an Adaptive Modulation and Coding (AMC) subchannel allocation scheme, in which a subchannel comprising at least one bin comprising a first plurality of continuous subcarriers in a frequency domain is allocated, and a diversity subchannel allocation scheme, in which a subchannel comprising a second plurality of scattered subcarriers in the frequency domain is allocated, according to a level of frequency selectivity of an unused idle frequency band; and
an allocation unit allocating at least one subchannel to the terminal according to the selected subchannel allocation scheme.

50. The apparatus of claim 49, further comprising an allocation information transmitter transmitting information on the allocated subchannel to the terminal.

51. The apparatus of claim 49, wherein the AMC subchannel allocation scheme comprises a band-type AMC subchannel allocation scheme, in which the subchannel is allocated with a band made up of M continuous bins in the frequency domain, where M is a natural number equal to or greater than 2, and a scattered AMC subchannel allocation scheme, in which the subchannel is allocated with a single bin or at least two bins regardless of continuity in the frequency domain,
wherein the selector selects the band-type AMC subchannel allocation scheme if the idle frequency band belongs to a best channel environment, in which the level of frequency selectivity is less than a first threshold, selects the scattered AMC subchannel allocation scheme if the idle frequency band belongs to a medium channel environment, in which the level of frequency selectivity is equal to or greater than the first threshold and less than a second threshold, or selects the diversity subchannel allocation scheme if the idle frequency band belongs to a worst channel environment, in which the level of frequency selectivity is equal to or greater than the second threshold.

52. A dynamic resource allocation apparatus of a terminal to which a base station (BS) allocates a subchannel, in an Orthogonal Frequency Division Multiple Access (OFDMA)-based cognitive radio system, the apparatus comprising:
an allocation information receiver receiving, from the BS, information on a subchannel allocated according to a subchannel allocation scheme selected by the BS based on a level of frequency selectivity of an unused idle frequency band from among an Adaptive Modulation and Coding (AMC) subchannel allocation scheme, in which a subchannel comprising at least one bin comprising a first plurality of continuous subcarriers in a frequency domain is allocated, and a diversity subchannel allocation scheme, in which a subchannel comprising a second plurality of scattered subcarriers in the frequency domain is allocated; and
a communication unit communicating with the BS using the allocated subchannel based on the received information on the allocated subchannel.

53. The apparatus of claim 52, further comprising a channel state information (CSI) transmitter receiving a request from the BS for CSI comprising information on a channel state of each band if the selected subchannel allocation scheme is the band-type AMC subchannel allocation scheme or information on a channel state of each group if the selected subchannel allocation scheme is the scattered AMC subchannel allocation scheme, detecting a channel state of each band or each group, and transmitting CSI containing information on the detected channel states to the BS,
wherein the allocated subchannel is a subchannel having a good channel state, which is selected by the BS based on the CSI.

54. The apparatus of claim 52, further comprising a channel environment information transmitter receiving information on the idle frequency band from the BS, detecting a level of frequency selectivity of the idle frequency band, and transmitting channel environment information containing information on the detected level of frequency selectivity to the BS.
